(19) United States
(12) Patent Application Publication
(10) Pub. No.: US 2009/0034218 A1
(43) Pub. Date: Feb. 5, 2009

(54) PRINTED CIRCUIT BOARD ASSEMBLY

(75) Inventor: CHIH-KAI HU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/946,481

(22) Filed: Nov. 28, 2007

(30) Foreign Application Priority Data
Aug. 3, 2007 (CN) 200710075539.3

(51) Int. Cl. H01R 9/00

(52) U.S. Cl. 361/772

(57) ABSTRACT

A printed circuit board assembly (20) is provided. The printed circuit board assembly includes a main printed circuit board (22), an accessorial printed circuit board (26), and a frame (24). The main printed circuit board includes at least one electronic component (222). The frame is secured to the main printed circuit board. The accessorial printed circuit board is attached to the main printed circuit board. The accessorial printed circuit board includes a shielding area (262). The shielding area is configured for engaging with the frame, whereby the shielding area and the frame cooperatively shield the at least one electronic component therein.

### BACKGROUND OF THE INVENTION

1. Field of the Invention

The present invention relates to printed circuit board assemblies, and particularly to a printed circuit board assembly used in an electronic device.

2. Description of Related Art

An electronic device (e.g., a mobile phone, a personal digital assistant, and etc.) generally incorporates a main printed circuit board therein. The main printed circuit board is used to mount various kinds of electronic components thereon. In order to place more electronic components inside the electronic device, an accessorial printed circuit board is usually required to be attached on the main printed circuit board. The accessorial printed circuit board is used to mount additional electronic components thereon, which cannot be mounted on the main printed circuit board for lack of mounting space. For decreasing or ceasing electromagnetic interference between the electronic components disposed on the main printed circuit board and the accessorial printed circuit board, a typical shielding case is used to shield respective electronic components therein.

Referring to FIG. 1, a typical printed circuit board assembly 10 includes a main printed circuit board 12, an accessorial printed circuit board 14, and a shielding case 16. The main printed circuit board 12 has at least one electronic component 122 disposed thereon. The shielding case 16 includes a frame 162 and a cover 164. The frame 162 is welded to the main printed circuit board 12. The cover 164 is welded to the frame 162. Thus, the frame 162 and the cover 164 cooperatively enclose and shield the electronic components 122 therein. The electronic components 122 enclosed in the shielding case 16 cease from being electromagnetically interfered by the exterior electromagnetic waves, e.g., generated by other electronic components disposed around the shielding case 16. The accessorial printed circuit board 14 is stacked and mounted on the main printed circuit board 12. At this case, the accessorial printed circuit board 14 is located above the shielding case 16.

However, due to the shielding case 16 being placed in-between the main printed circuit board 12 and the accessorial printed circuit board 14, the whole height of the printed circuit board assembly 10 is inevitably increased. Thus, this configuration is disadvantageous for producing the electronic device with a small size.

Therefore, a heretofore-unaddressed need exists in the art to address the aforementioned deficiencies and inadequacies.

### SUMMARY

In one aspect, a printed circuit board assembly is provided. The printed circuit board assembly includes a main printed circuit board, an accessorial printed circuit board, and a frame. The main printed circuit board includes at least one electronic component. The frame is placed in-between the main printed circuit board and the accessorial printed circuit board. When the accessorial printed circuit board is stacked on the main printed circuit board, the at least one electronic component is shielded within the main printed circuit board, the accessorial printed circuit board, and the frame.

In another aspect, a printed circuit board assembly is provided. The printed circuit board assembly includes a main printed circuit board, an accessorial printed circuit board, and a frame. The main printed circuit board includes at least one electronic component. The frame is secured to the main printed circuit board. The accessorial printed circuit board is attached to the main printed circuit board. The accessorial printed circuit board includes a shielding area. The shielding area is configured for engaging with the frame, whereby the shielding area and the frame cooperatively shield the at least one electronic component therein.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present printed circuit board assembly can be better understood with reference to the following drawings. These drawings are not necessarily drawn to scale, the emphasis instead being placed upon clearly illustrating the principles of the present printed circuit board assembly. Moreover, in the drawings like reference numerals designate corresponding parts throughout the several views. Wherever possible, the same reference numbers are used throughout the drawings to refer to the same or like elements of an embodiment.

FIG. 1 is an exploded, isometric view of a typical printed circuit board assembly;

FIG. 2 is an exploded, isometric view of a printed circuit board assembly in accordance with a present embodiment;

FIG. 3 is an isometric view of a frame of the printed circuit board assembly shown in FIG. 2;

FIG. 4 is an isometric view of an accessorial of printed circuit board the printed circuit board assembly shown in FIG. 2; and

FIG. 5 is an isometric, assembled view of the printed circuit board assembly shown in FIG. 2.

### DETAILED DESCRIPTION OF THE EMBODIMENTS

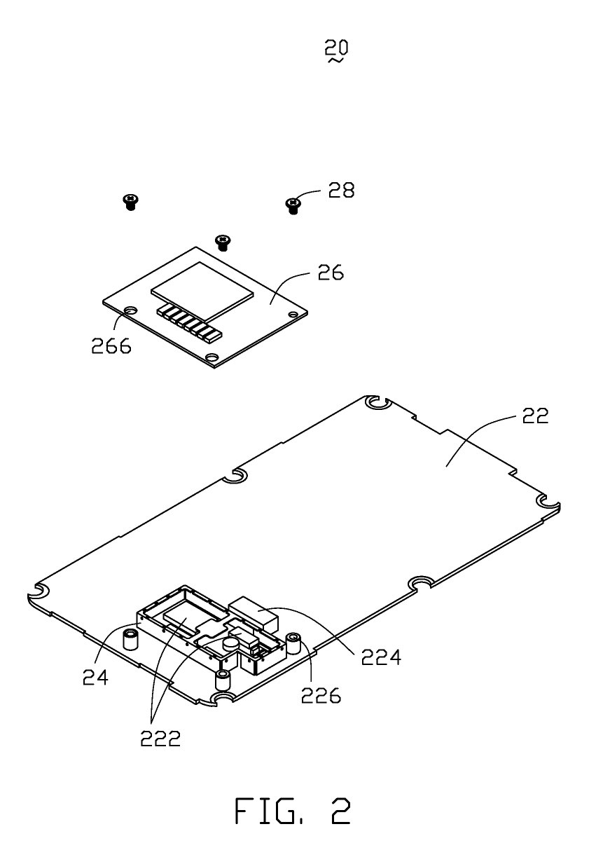

The present printed circuit board assembly for an electronic device is described here in conjunction with the accompanying drawings in FIGS. 2 through 5. The printed circuit board assembly can be assembled in the electronic device, such as the mobile phone, the personal digital handset, or the like.

Referring to FIG. 2, the printed circuit board assembly 20 includes a main printed circuit board 22, a frame 24, and an accessorial printed circuit board 26. The accessorial printed circuit board 26 is stacked/attached on the main printed circuit board 22, and the frame 24 is placed in-between the main printed circuit board 22 and the accessorial printed circuit board 26.

The main printed circuit board 22 has at least one electronic component 222, a connector 224, and three screw bolts 226 thereon. In assembly, the connector 224 electronically coupled the main printed circuit board 22 with the accessorial printed circuit board 26, enabling data/signal to be transferred between the main printed circuit board 22 and the accessorial printed circuit board 26.

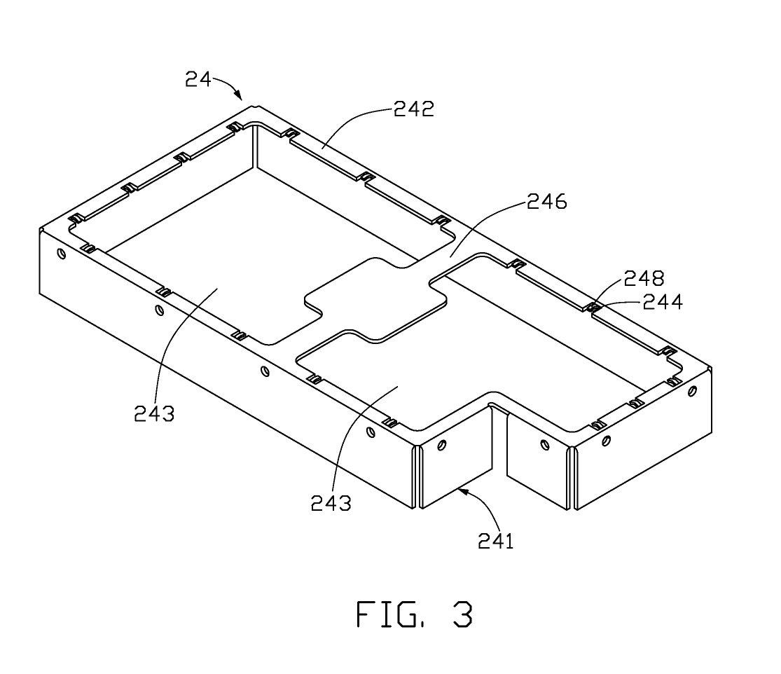

Referring also to FIG. 3, the frame 24 is generally rectangular-shaped and is advantageously made of metal material. The frame 24 is advantageously punched with an open end 241 and a partially closed end 242. The partially closed end 242 contacts with the accessorial printed circuit board 26. The open end 241 is firmly attached to (e.g., welded to) the main printed circuit board 22.

The partially closed end 242 includes two openings 243, a plurality of through slots 244, a connecting portion 246, and a plurality of elastic sheets 248. The two openings 243 are defined through the partially closed end 242, thus forming the connecting portion 246 connecting with two opposite sides of the partially closed end 242. The through slots 244 are defined through the partially closed end 242. Each through slot 244 communicates with one of the two openings 243. The through slots 244 are respectively arranged/distributed along sides of the partially closed end 242. The elastic sheets 248 correspond to the through slots 244, respectively. Each elastic sheet 248 is formed and accommodated within each through slot 244 with at least one portion located above the end wall of the partially closed end 242.

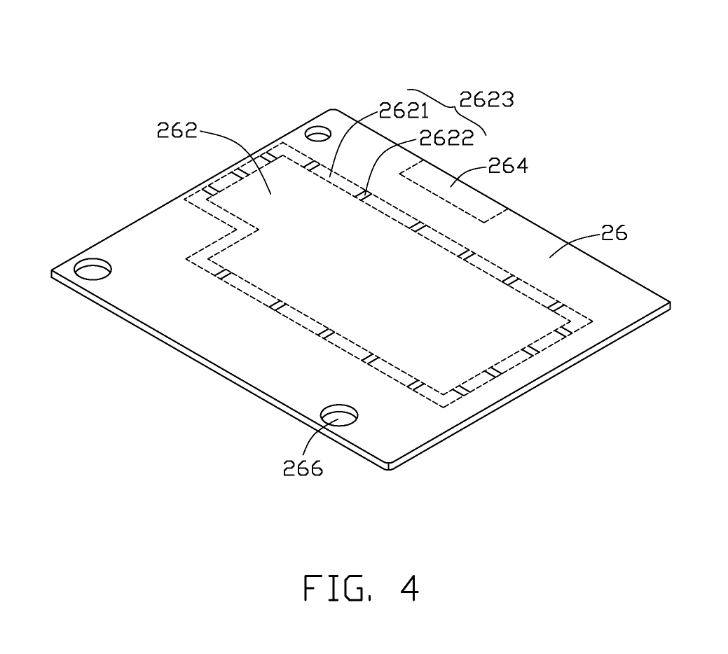

Referring also to FIG. 4, the accessorial printed circuit board 26 includes a shielding area 262, an electronically connecting area 264, and three screw holes 266. The shielding area 262 is used to engage with the frame 24 to shield the at least one electronic component 222 of the main printed circuit board 22. The shielding area 262 has an essentially the same shape and size as that of the partially closed end 242 of the frame 24. The shielding area 262 includes a current-conductive layer 2621 (e.g., a metallic layer) and a plurality of ground pads 2622 (e.g., metallic pads). The current-conductive layer 2621 is disposed within the shielding area 262. Each ground pad 2622 connects with the current-conductive layer 2621 and a corresponding grounding loop 2623 is formed. The ground pads 2622 are exposed on the surface of the accessorial printed circuit board 26. It is to be understood that the current-conductive layer 2621 can be configured (e.g., structured and arranged) to connect with the plurality of ground pads 2622 to form grounding loops 2623 in other ways, e.g., the current-conductive layer 2621 being exposed outside the accessorial printed circuit board 26 to connect with the plurality of ground pads 2622.

The plurality of ground pads 2622 corresponds to the plurality of elastic sheets 248, respectively. In other words, each ground pad 2622 is arranged to contact with the one corresponding elastic sheet 248 as the shielding area 262 engaging with the partially closed end 242 of the frame 24.

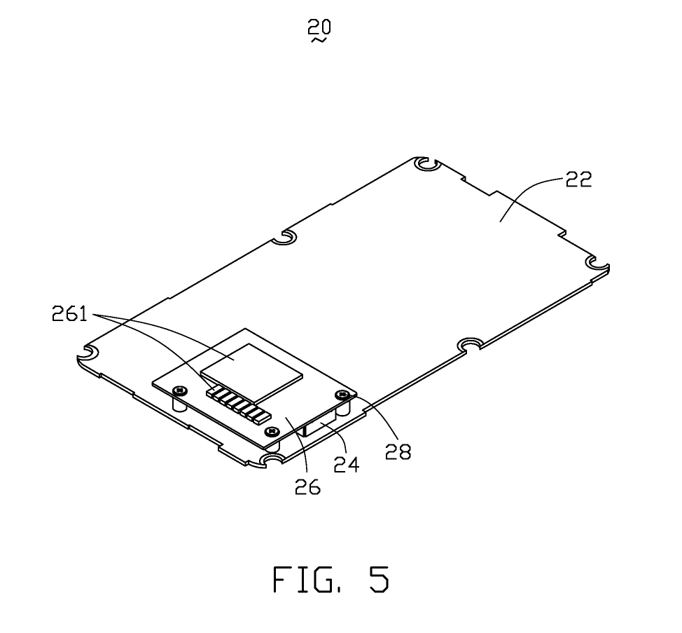

The electronically connecting area 264 functions to connect electronically with the connector 224 of the main printed circuit board 22, whereby data/signals can be transferred between the main printed circuit board 22 and the accessorial printed circuit board 26. The three screw holes 266 respectively correspond to the three screw bolts 226 of the main printed circuit board 22. Best shown in FIG. 5, three screws 28, engaging through the three screw holes 266, engages into the three screw bolts 226 to secure the accessorial printed circuit board 26 with the main printed circuit board 22.

Referring further to FIG. 5, during the assemble process of the stack printed circuit board assembly 20 printed circuit board, the frame 24 is attached to the main printed circuit board 22 via a welding method. The accessorial printed circuit board 26 is assembled with the main printed circuit board 22 with the shielding area 262 of the accessorial printed circuit board 26 engaging with the partially closed end 242 of the frame 24 of the main printed circuit board 22. In this case, the ground pads 2622 contact elastically with the elastic sheets 248, respectively. Each ground pad 2622, each elastic sheet 248, and the frame 24 cooperatively form a grounding loop. The at least one electronic component 222 is thus shielded by the shielding area 262 and the frame 24 with an effective EMI (electromagnetic interference) shielding.

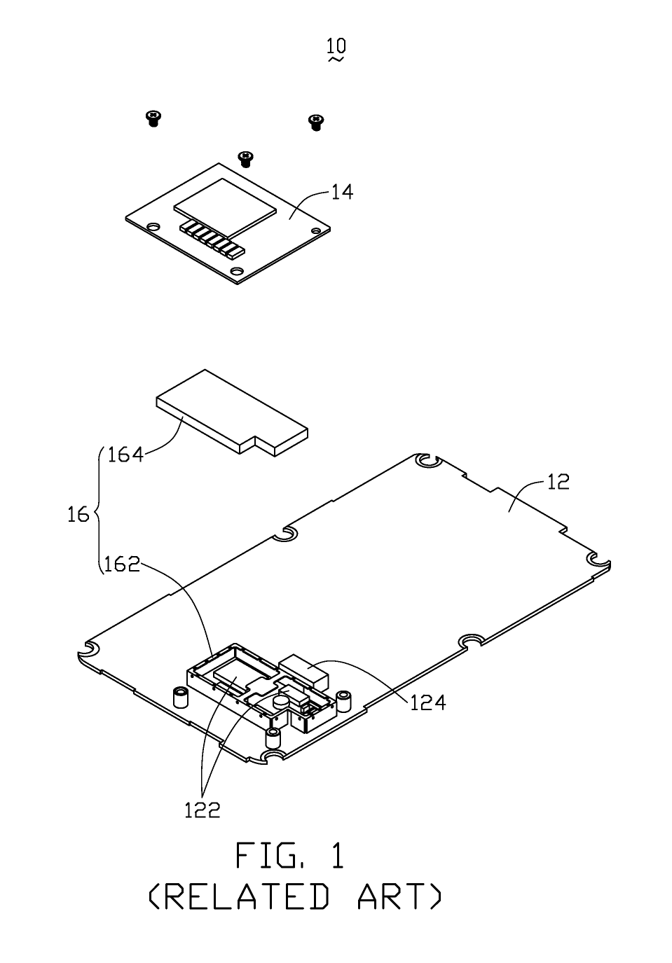

One main advantage of the present embodiment embodies that the cover 164 of the shielding case 16 (shown in FIG. 1) of the related art is omitted. By providing the accessorial printed circuit board 26 with the shielding area 262, the shielding area 262 and the frame 24 actually forms a visual shielding case to achieve an effective shielding. As such, the gap between the accessorial printed circuit board 26 and the frame 24 is eliminated. The height of the printed circuit board assembly 20 is decreased. Moreover, due to the cover 164 of the shielding case 16 (shown in FIG. 1) of the related art being omitted, the height of the printed circuit board assembly 20 is thus lowered.

Another main advantage of the present embodiment reflects that, due to the cover 164 of the related art being omitted, materials usage in manufacturing the printed circuit board assembly 20 has also decreased.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A printed circuit board assembly, comprising:
a main printed circuit board including at least one electronic component;
a frame secured to the main printed circuit board; and
an accessorial printed circuit board attached to the main printed circuit board, comprising a shielding area, the shielding area configured for engaging with the frame, wherein the shielding area and the frame cooperatively shield the at least one electronic component therein.

2. The printed circuit board assembly as claimed in claim 1, wherein the frame comprises a plurality of elastic sheets, the shielding area comprises a plurality of ground pads, and the ground pads contact with the elastic sheets, respectively.

3. The printed circuit board assembly as claimed in claim 2, wherein the shielding area further comprises a current-conductive layer, the current-conductive layer configured in a manner that the current-conductive layer and the plurality of ground pads form a grounding loop.

4. The printed circuit board assembly as claimed in claim 3, wherein the current-conductive layer is disposed inside of the shielding area and connects with the plurality of ground pads.

5. The printed circuit board assembly as claimed in claim 3, wherein the current-conductive layer is exposed to connect with the plurality of ground pads.

6. The printed circuit board assembly as claimed in claim 3, wherein the current-conductive layer connect with at least one ground pads.

7. The printed circuit board assembly as claimed in claim 3, wherein the current-conductive layer is a metallic layer, and the ground pads are metallic pads.

8. The printed circuit board assembly as claimed in claim 2, wherein the frame further comprises a plurality of through slots, each elastic sheets being accommodated within each corresponding through slot.

9. The printed circuit board assembly as claimed in claim 7, wherein the frame further comprises an opening end and a partially closed end, the partially closed end comprises at least one opening defined therethrough, the through slots are defined through the partially closed end, and each through slot communicates with one of the at least one opening.

10. The printed circuit board assembly as claimed in claim 8, wherein the through slots are respectively defined along sides of the partially closed end.

11. The printed circuit board assembly as claimed in claim 8, wherein the partially closed end comprises two openings defined therethrough, each through slot communicating with one of the two openings, the partially closed end further comprises a connecting portion, and the connecting portion connects with two opposite sides of the partially closed end.

12. The printed circuit board assembly as claimed in claim 7, wherein the frame further comprises an opening end and a partially closed end, the through slots are defined through the partially closed end, and each elastic sheet is accommodated within each through slot with at least one portion located above the partially closed end.

13. The printed circuit board assembly as claimed in claim 1, wherein the accessorial printed circuit board is screwed with the main printed circuit board.

14. A printed circuit board assembly, comprising:
a main printed circuit board including at least one electronic component;
an accessorial printed circuit board; and
a frame sandwiched between the main printed circuit board and the accessorial printed circuit board;
wherein when the accessorial printed circuit board is stacked on the main printed circuit board, the at least one electronic component is shielded within the main printed circuit board, the accessorial printed circuit board, and the frame.

15. The printed circuit board assembly as claimed in claim 14, wherein the accessorial printed circuit board comprises a shielding area, the shielding area configured for engaging with the frame, wherein the shielding area and the frame cooperatively shield the at least one electronic component therein.

16. The printed circuit board assembly as claimed in claim 15, wherein the frame comprises an opening end and a partially closed end, the opening end is secured to the main printed circuit board, and the partially closed end engages with the shielding area.

17. The printed circuit board assembly as claimed in claim 15, wherein the shielding area has an essentially the same shape and size as that of the partially closed end.

18. The printed circuit board assembly as claimed in claim 14, wherein the shielding area comprises a current-conductive layer and a plurality of ground pads, the frame comprises a plurality of elastic sheets, and the current-conductive layer, the ground pads, and the elastic sheets cooperatively form grounding loops.

19. The printed circuit board assembly as claimed in claim 18, wherein the ground pads contact elastically with the elastic sheets, respectively.

20. The printed circuit board assembly as claimed in claim 14, wherein the accessorial printed circuit board is screwed with the main printed circuit board.
